(19) United States
(12) Patent Application Publication
(10) Pub. No.: US 2015/0355219 A1
(43) Pub. Date: Dec. 10, 2015

(54) MULTI-AXIS SENSOR

(71) Applicant: SAMSUNG ELECTRO-MECHANICS CO., LTD., Gyeonggi-Do (KR)

(72) Inventors: Pil Joong KANG, Gyeonggi-Do (KR); Jung Won LEE, Gyeonggi-Do (KR); Hyun Kee LEE, Gyeonggi-Do (KR); Jong Hyeong SONG, Gyeonggi-Do (KR)

(73) Assignee: SAMSUNG ELECTRO-MECHANICS CO., LTD., Gyeonggi-Do (KR)

(21) Appl. No.: 14/589,206

(22) Filed: Jan. 5, 2015

(30) Foreign Application Priority Data
Jun. 10, 2014 (KR) 10-2014-0070115

(51) Int. Cl. G01P 15/12; G01P 15/093; G01P 15/125

(52) U.S. Cl. CPC G01P 15/123; G01P 15/125; G01P 15/093

(57) ABSTRACT

Embodiments of the invention provide a multi-axis sensor, including a first sensor embedded in an embedded substrate to sense a position, and a second sensor formed on a lower cap substrate bonded on the embedded substrate by a wafer level package scheme to sense an inertial force.

### CROSS REFERENCE TO RELATED APPLICATION

This application claims the benefit of and priority under 35 U.S.C. §119 to 35 U.S.C. §119 to Korean Patent Application No. KR 10-2014-0070115, entitled “MULTI-AXIS SENSOR,” filed on Jun. 10, 2014, which is hereby incorporated by reference in its entirety into this application.

### BACKGROUND

1. Field of the Invention

The present invention relates to a multi-axis sensor.

2. Description of the Related Art

Electronic parts included in mobile electronics, such as a mobile phone and a tablet PC, have two important goals (i.e., competitive goals). One goal is to reduce a size of the electronic parts while making performance of the electronic parts the same or more excellent. The other goal is to minimize power consumption.

Electronic parts, in particular, various sensors, such as an angular velocity sensor, an accelerator sensor, an earth magnetic field sensor, and a pressure sensor measure a variety of #4779992.1 information and provide the measured information as described, for example, in the following Korean Patent No. 10-0855471.

As described above, each information of various sensors may be used as information required for functions of the mobile electronics but to provide more various and complicated functions to users of the mobile electronics, since the information of various sensors is used as the information required for the functions of the mobile electronics only when being calculated overall, a use of a multi-axis sensor in which various sensors are integrated is increasingly growing recently.

Further, a demand for a method for appropriately designing and manufacturing a multi-axis sensor capable of reducing power consumption using a scheme for determining various sensors using a single integrated information processing device, obtaining information by driving only the required sensors when necessary, for example, tends to be increased.

### SUMMARY

Accordingly, embodiments of the invention have been made to provide a multi-axis sensor, which may be miniaturized and reduce power consumption by improving a structure of a multi-axis sensor.

According to at least one embodiment, a multi-axis sensor includes a first sensor embedded in an embedded substrate to sense a position; and a second sensor formed on a lower cap substrate bonded on the embedded substrate by a wafer level package (WLP) scheme to sense an inertial force.

According to at least one embodiment, the embedded substrate and the lower cap substrate are gap filled by having a vertical conductive epoxy interposed therebetween and bonded to each other.

According to at least one embodiment, the embedded substrate and the lower cap substrate each have a vertical length of 2 mm to 4 mm and a horizontal length of 1 mm to 2 mm.

According to at least one embodiment, the embedded substrate has a height of 100 μm to 300 μm.

According to at least one embodiment, the lower cap substrate includes an electrical wiring formed in horizontal/vertical directions and is made of a hermetic seal bonding material.

According to at least one embodiment, the lower cap substrate is made of any one of low temperature co-fired ceramic (LTCC), glass, interposer, application specific integrated circuit (ASIC), and silicon.

According to at least one embodiment, the first sensor is a 3-axis earth magnetic field sensor, which is formed by a single-in-line package (SIP) scheme to sense a position.

According to at least one embodiment, the earth magnetic field sensor has a width of 1 m² to 1.5 m².

According to at least one embodiment, one surface of the earth magnetic field sensor is provided with an electrode pad, and the other surface opposite to the one surface of the earth magnetic field sensor is bonded and embedded in a cavity formed on the embedded substrate, so that the electrode pad is exposed to the outside.

According to at least one embodiment, the electrode pad is formed on upper and lower surfaces or both sides of the earth magnetic field sensor.

According to at least one embodiment, the cavity is formed to be wider than the earth magnetic field sensor.

According to at least one embodiment, the embedded substrate includes a core layer provided with the cavity, an insulating layer deposited on a lower surface of the core layer to support the earth magnetic field sensor, a plurality of wiring patterns formed on the core layer and electrically connected to the earth magnetic field sensor which is boned and embedded in the cavity, and a build-up layer stacked on an upper surface of the core layer including the earth magnetic field sensor.

According to at least one embodiment, the embedded substrate further includes a plurality of through holes which are formed by vertically penetrating through the build-up layer, the core layer, and the insulating layer and electrically connected to the earth magnetic field sensor through the wiring patterns.

According to at least one embodiment, the embedded substrate includes a core layer provided with the cavity, an insulating layer formed on a lower surface of the core layer to support the earth magnetic field sensor, and a plurality of wiring patterns formed in the insulating layer and electrically connected to the earth magnetic field sensor which is boned and embedded in the cavity.

According to at least one embodiment, the second sensor includes a 3-axis acceleration sensor and a 3-axis angular velocity sensor.

According to at least one embodiment, the second sensor includes a hermetic seal which is made of any one of glass, silicon nitride and metal.

According to at least one embodiment, the second sensor includes an upper cap substrate and the lower cap substrate, and the upper cap substrate and the lower cap substrate are each formed of an application specific integrated circuit (ASIC).

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a plan view illustrating a multi-axis sensor according to an embodiment of the invention.

FIG. 2 is a cross-sectional view illustrating an angular velocity sensor and an earth magnetic field sensor in side ‘A’ of FIG. 1 according to an embodiment of the invention.

FIG. 3 is a cross-sectional view illustrating an accelerator sensor, an angular velocity sensor, and an earth magnetic field sensor in side ‘B’ of FIG. 1 according to an embodiment of the invention.

FIG. 4 is a diagram illustrating a method for forming an earth magnetic field sensor of a multi-axis sensor according to an embodiment of the invention.

FIG. 5 is a cross-sectional view illustrating a process for embedding an earth magnetic field sensor of a multi-axis sensor according to an embodiment of the invention.

FIG. 6 is a diagram illustrating a method for forming a second sensor of a multi-axis sensor according to an embodiment of the invention.

FIG. 7 is a cross-sectional view illustrating a process for bonding a lower cap substrate, which is provided with the second sensor of the multi-axis sensor, according to an embodiment of the invention, on an embedded substrate.

### DETAILED DESCRIPTION

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. Like reference numerals refer to like elements throughout the specification.

Hereinafter, various embodiments of the present invention will be described in detail with reference to the accompanying drawings.

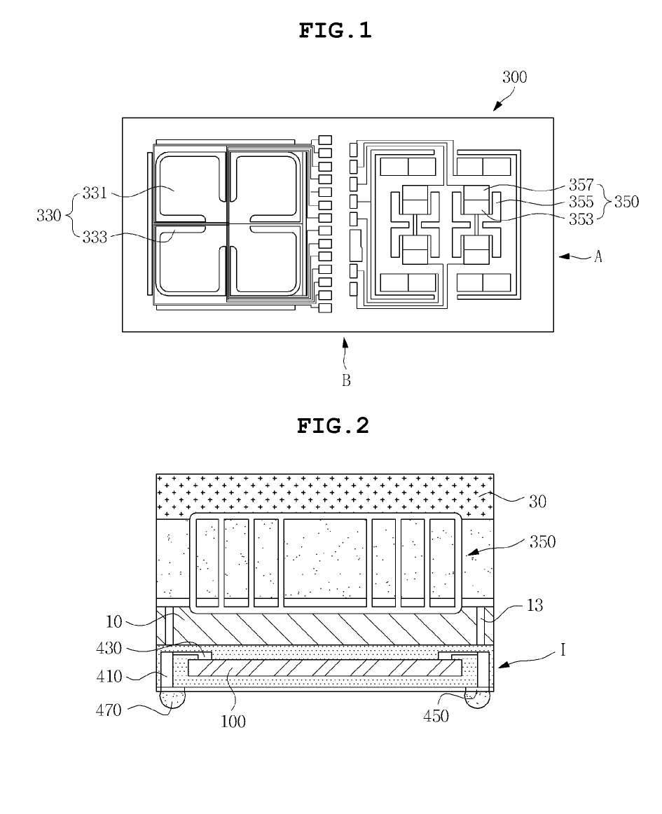

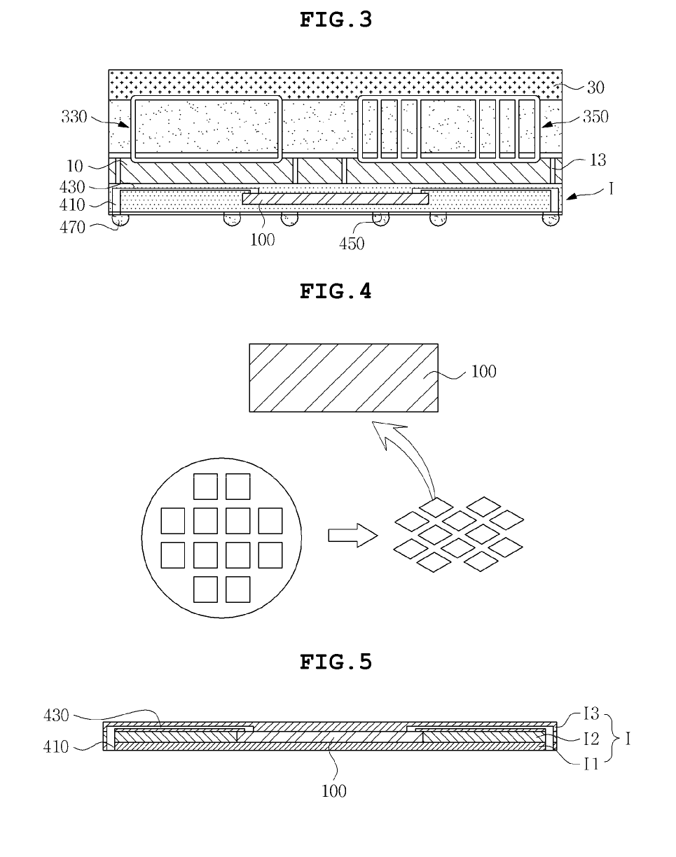

FIG. 1 is a plan view illustrating a multi-axis sensor according to an embodiment of the invention, FIG. 2 is a cross-sectional view illustrating an angular velocity sensor and an earth magnetic field sensor in side ‘A’ of FIG. 1 according to an embodiment of the invention, and FIG. 3 is a cross-sectional view illustrating an accelerator sensor, an angular velocity sensor, and an earth magnetic field sensor in side ‘B’ of FIG. 1 according to an embodiment of the invention.

As illustrated in FIGS. 1 to 3, a multi-axis sensor, according to at least one embodiment of the invention (hereinafter, referred to as a “multi-axis sensor”), includes a 3-axis first sensor embedded in an embedded substrate I and a 6-axis second sensor bonded on the embedded substrate I.

According to at least one embodiment, the first sensor is a 3-axis earth magnetic field sensor 100 formed by an SIP scheme and the second sensor includes a 6-axis inertial sensor 300 formed by a WLP scheme. According to at least one embodiment, the inertial sensor 300 is directly formed on a lower cap substrate 10 by the WLP scheme and has a hermetic seal.

For example, the 3-axis earth magnetic field sensor 100 is embedded in the embedded substrate I, and the 6-axis inertial sensor 300, such as a 3-axis accelerator sensor 330 and a 3-axis angular velocity sensor 350, is formed on the lower cap substrate 10.

According to at least one embodiment, the multi-axis sensor is a 9-axis sensor capable of sensing a straight line and an angle and sensing electromagnetic motions by bonding the lower cap substrate 10 provided with the 6-axis inertial sensor 300 on the embedded substrate I in which the 3-axis earth magnetic field sensor 100 is embedded. Further, the multi-axis sensor, according to at least one embodiment of the invention, is formed in a single module by forming the 9-axis sensor as described above and then overall packaging it.

As described above, the multi-axis sensor, which is the 9-axis sensor capable of sensing an inertial force, thus, a straight line and an angle and sensing a position, thus, electromagnetic motions overall calculates, for example, information of the straight line, the angle, and the electromagnetic motion, of various sensors to be utilized as information required for functions of mobile electronics and therefore provides various, complicated functions to users of mobile electronics.

According to at least one embodiment, the embedded substrate I includes a solder ball pad 450 and a solder ball 470. Further, the embedded substrate I has a vertical length of 2 mm to 4 mm, a horizontal length of 1 mm to 2 mm, and a height of 100 μm to 300 μm.

Further, a predetermined region of the embedded substrate I is provided with a cavity in which an earth magnetic field sensor 100 is accommodated. The cavity is formed to be slightly larger than a size of the earth magnetic field sensor 100, thus, wider than the earth magnetic field sensor 100. According to at least one embodiment, the cavity is formed using, for example, a laser drill, or a relatively inexpensive router and punching, as non-limiting examples. Therefore, the earth magnetic field sensor 100, according to at least one embodiment, is mounted on the embedded substrate I in the cavity.

Further, a build-up layer, which is an insulating layer, is stacked on the embedded substrate I on which the earth magnetic field sensor 100 is mounted. Therefore, the earth magnetic field sensor 100 is fixed in a state in which it is buried in the cavity by an insulating material of the build-up layer. According to at least one embodiment, the build-up layer is made of a reinforcement material, such as epoxy resin and glass, as non-limiting examples.

According to at least one embodiment, the embedded substrate I includes a through hole 410 and a wiring pattern 430. According to at least one embodiment, the through hole 410 is formed to penetrate through the embedded substrate I and the wiring pattern 430 is electrically connected between the earth magnetic field sensor 100 and the through hole 410. Therefore, a signal of the earth magnetic field sensor 100 embedded in the embedded substrate I is transferred to the outside through the through hole 410, the wiring pattern 430, the solder ball pad 450, and the solder ball 470.

Further, one surface of the earth magnetic field sensor 100, according to at least one embodiment, is provided with an electrode pad (not illustrated), but the other surface opposite to the one surface thereof is bonded and mounted in the cavity formed on the embedded substrate I, so that the electrode pad faces up, thus, the electrode pad is exposed to the outside. Therefore, the electrode pad is electrically connected to the wiring pattern 430. Further, the electrode pad is formed on upper and lower surfaces of the earth magnetic field sensor 100 or both sides thereof.

According to at least one embodiment, the lower cap substrate 10 has a vertical length of 2 mm to 4 mm and a horizontal length of 1 mm to 2 mm. Further, the lower cap substrate 10, according to at least one embodiment, is a substrate on which electrical wirings is formed horizontally/vertically and a hermetic seal bonding is made of LTCC, glass, interposer, ASIC provided with the through hole 410, silicon provided with vertical/horizontal wirings, as non-limiting examples.

For example, the multi-axis sensor is miniaturized and reduces power consumption, since the 6-axis inertial sensor 300 is formed in the ASIC used as the lower cap substrate 10 and the ASIC is bonded on the embedded substrate I in which the 3-axis earth magnetic field sensor 100 is embedded to make the 9-axis sensor and the ASIC be disposed to be close to each other.

According to at least one embodiment, when a microelectromechanical systems (MEMS) and the ASIC are disposed to be close to each other, performance is improved. Therefore, one of the matters, which are to be considered by MEMS designers at the time of designing, results from a necessity of a simultaneous operation of an integrated circuit, such as ASIC and the MEMS. Therefore, it is very important to package the components to be close to each other.

Hereinafter, the earth magnetic field sensor 100 embedded in the embedded substrate I will be described in more detail.

According to at least one embodiment, the earth magnetic field sensor 100 is the 3-axis sensor, which is formed by an SIP scheme to measure an intensity of geo-magnetic field and senses an electromagnetic motion. According to at least one embodiment, the earth magnetic field sensor 100 is configured of one chip using the MEMS technology. Further, the earth magnetic field sensor 100, according to at least one embodiment, has a width of 1 m² to 1.5 m².

According to at least one embodiment, the earth magnetic field sensor 100 uses three independent sensors, such as a hall sensor, a magneto-resistance (MR) sensor, and a magneto-impedance (MI) sensor, to implement the 3-axis sensor.

According to at least one embodiment, the hall sensor, the MR sensor, and the MI sensor are manufactured in a 1-axis since a sensing direction thereof is only one. For example, the earth magnetic field sensor 100 includes a first MR sensor sensing a magnetic field in an X-axis direction, a second MR sensor sensing a magnetic field in a Y-axis direction, and the hall sensor sensing a magnetic field in a Z-axis direction which are not illustrated, in which the first and second MR sensors is disposed at one side of the hall sensor to form a right angle to each other.

Hereinafter, the 6-axis inertial sensor 300 formed by the WLP scheme will be described in more detail.

According to at least one embodiment, the inertial sensor 300 is a 6-axis inertial sensor, which includes a 3-axis accelerator sensor 330 and a 3-axis angular velocity sensor 350 formed by the WLP scheme.

According to at least one embodiment, the inertial sensor 300 requires a hermetic seal to prevent, for example, water and air, as non-limiting examples, from being introduced and therefore is formed on the lower cap substrate 10 by the WLP scheme. According to at least one embodiment, the WLP scheme implements the hermetic seal of the inertial sensor 300 using two wafers of the lower cap substrate 10 and an upper cap substrate 30 to be described below at a wafer level and then dicing it at the wafer level, and therefore there is no possibility that air, dust, particles, moisture, for example, are stuck to or introduced into the 6-axis inertial sensor at the time of a cutting operation.

According to at least one embodiment, the accelerator sensor 330 is a 3-axis sensor including the upper cap substrate 30, and measuring accelerations of X, Y, and Z axes and sensing a motion of the straight line. According to at least one embodiment, the acceleration sensor 330 needs to have high resolution and be miniaturized to detect fine acceleration.

For example, the acceleration sensor 330 includes a mass body part 331 and a flexible beam part 333 connected to the mass body part 331 and converts the motion of the mass body part 331 or the flexible beam part 333 into an electrical signal.

According to at least one embodiment, when the acceleration is applied to the acceleration sensor 330 by an external force, the acceleration sensor 330 extracts a potential difference generated by a difference in resistance variations of four piezo resistance elements (not illustrated) detecting the acceleration of each mass body part 331 and senses the extracted potential difference as a value of the acceleration, by changing an electrical resistance of the piezo resistance elements disposed at the flexible beam part 333 due to a displacement of the mass body part 331 and a deformation of the flexible beam part 333. Further, the acceleration sensor 330 includes wiring (not illustrated), which electrically connects the flexible beam part 333 to the piezo resistance elements.

According to at least one embodiment, the flexible beam part 333 supports the mass body part 331, and first to fourth flexible beam parts each are disposed at a center of each side around the mass body part 331.

For example, an end of the first flexible part is provided with a semiconductor piezo resistance element for detecting X-axis acceleration and an end of the second flexible part is provided with a semiconductor piezo resistance element for detecting Z-axis acceleration, such that the first flexible part and the second flexible part detect accelerations in X-axis and Z-axis directions. Further, the third flexible part and the fourth flexible part vertically disposed to the first flexible part and the second flexible part each are provided with the semiconductor piezo resistance element for detecting Y-axis acceleration, and thus the acceleration in the Y-axis direction may be detected.

According to at least one embodiment, the angular velocity sensor 350 is a 3-axis sensor including the upper cap substrate 30 and measuring angular velocities of X, Y, and Z axes and senses a motion of the angle. According to at least one embodiment, the angular velocity sensor 350 needs to have high resolution and be miniaturized to detect fine angular velocity.

For example, the angular velocity sensor 350 includes a sensor mass body 353, a frame 355, and a flexible part 357.

According to at least one embodiment, the sensor mass body 353 is displaced by a Coriolis force and includes a first mass body and a second mass body formed to have the same size and shape. According to at least one embodiment, the first and second mass bodies generally have a square pillar shape, but are not limited thereto, and therefore they may be formed to have all shapes known in the art.

Further, the flexible parts 357 each connected to the first and second mass bodies are each connected to the frames 355; and therefore, the first and second mass bodies are supported by the frames 355. According to at least one embodiment, the frame 355 has the sensor mass body 353 disposed therein and is connected to the sensor mass body 353 by the flexible part 357.

According to at least one embodiment, the frame 355 secures a space in which each of the first and second mass bodies connected to each other by the flexible part 357 is displaced and is a reference to displace the first and second mass bodies. Further, the frame 355, according to at least one embodiment, is formed at the same thickness as the flexible part 357.

According to at least one embodiment, the frame 355 is also formed to cover only a portion of the sensor mass body 353. Further, the frame 355, according to at least one embodiment, has a square pillar shape in which it has a square pillar shaped cavity formed at the center thereof, but is not limited thereto.

Further, the flexible part 357 is provided with a sensing means, which senses a displacement of the angle of the sensor mass body 353. Further, to measure a vibration displacement of the sensor mass body 353, the flexible parts 357 are separately disposed at a position spaced from the center of the sensor mass body 353 by a predetermined distance. According to at least one embodiment, the sensing means is not particularly limited, but may be formed to use, for example, a piezoelectric type, a piezoresistive type, a capacitive type, and an optical type, as non-limiting examples.

Hereinafter, a method for manufacturing a multi-axis sensor according to an embodiment of the invention will be described in more detail.

FIG. 4 is a diagram illustrating a method for forming an earth magnetic field sensor of a multi-axis sensor according to an embodiment of the invention. As illustrated in FIG. 4, the method for manufacturing a multi-axis sensor according to an embodiment of the invention forms the 3-axis earth magnetic field sensor 100 by the SIP scheme.

FIG. 5 is a cross-sectional view illustrating a process for embedding an earth magnetic field sensor of a multi-axis sensor according to an embodiment of the invention. As illustrated in FIG. 5, the earth magnetic field sensor 100 is embedded in the embedded substrate I. According to at least one embodiment, the embedded substrate I includes an insulating layer I1, a core layer I2, and a build-up layer 13.

For example, the cavity for accommodating the earth magnetic field sensor 100 is formed in a predetermined region of the core layer I2 and the insulating layer I1 for supporting the earth magnetic field sensor 100 is deposited on a lower surface of the core layer I2. According to at least one embodiment, the cavity is formed to be slightly larger than the size of the earth magnetic field sensor 100. According to at least one embodiment, the process for forming a cavity is performed using, for example, a laser drill or a relatively inexpensive router and punching, as non-limiting examples. Meanwhile, the insulating layer I1 is deposited on a lower surface of the core layer I2 to close a lower end of the cavity.

According to at least one embodiment, the earth magnetic field sensor 100 is mounted on the insulating layer I1 in the cavity. Next, the plurality of through holes 410 are formed by selectively etching the insulating layer I1 and the core layer I2 and the plurality of wiring patterns 430 is formed in a predetermined region on the core layer I2.

According to at least one embodiment, the through hole 410 vertically penetrates through the insulating layer I1 and the core layer I2. Further, the wiring pattern 430 is disposed on the earth magnetic field sensor 100 to be electrically connected between the earth magnetic field sensor 100 and the through hole 410. Further, the wiring pattern 430 is disposed under the earth magnetic field sensor 100 to be electrically connected to the earth magnetic field sensor 100 and the through hole 410. According to at least one embodiment, the wiring pattern 430 is formed in the insulating layer I1 and the earth magnetic field sensor 100 is mounted over the insulating layer I1, such that the wiring pattern 430 is disposed under the earth magnetic field sensor 100.

To be continued, the build-up layer 13, which is the insulating layer, is stacked on an upper surface of the core layer I2 including the through hole 410 and the wiring pattern 430. According to at least one embodiment, the build-up layer 13 is made of a reinforcement material, such as epoxy resin and glass, as non-limiting examples.

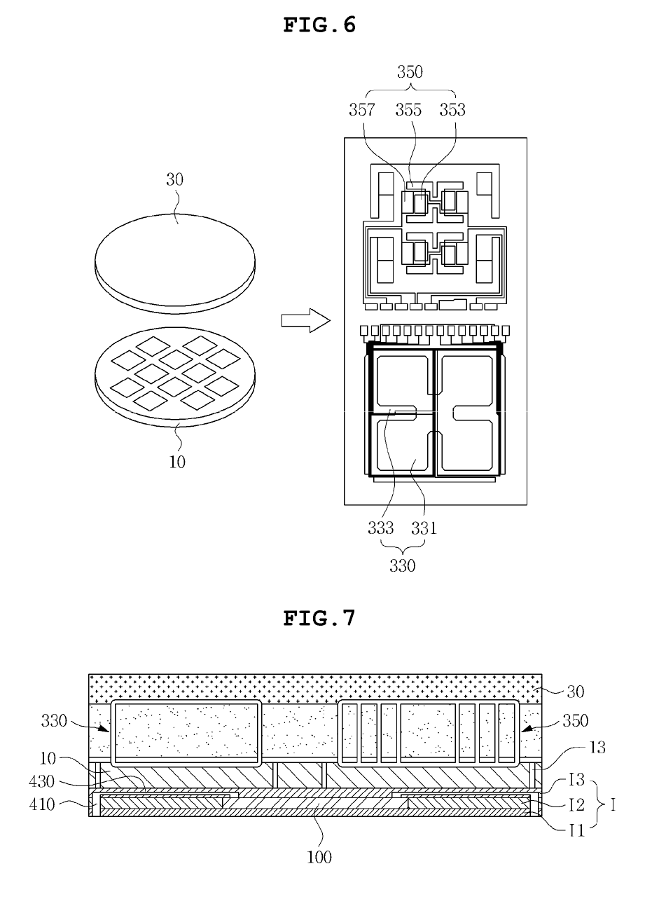

FIG. 6 is a diagram illustrating a method for forming a second sensor of a multi-axis sensor according to an embodiment of the invention; and as illustrated in FIG. 6, the inertial sensor 300, which is the second sensor is directly formed on the lower cap substrate 10 by the WLP scheme. According to at least one embodiment, the inertial sensor 300 is a 6-axis inertial sensor, which includes the 3-axis accelerator sensor 330 and the 3-axis angular velocity sensor 350. Meanwhile, in the process for forming the inertial sensor 300 and the earth magnetic field sensor 100, the inertial sensor 300 and the earth magnetic field sensor 100 are each formed by a separate process by the WLP scheme or the SIP scheme; and therefore, the formation sequence thereof is not determined. For example, the inertial sensor 300 is first formed on the lower cap substrate 10 by the WLP scheme and then the earth magnetic field sensor 100 is formed by the SIP scheme and embedded in the embedded substrate I.

According to at least one embodiment, the inertial sensor 300 requires the hermetic seal to prevent, for example, water and air, as non-limiting examples, from being introduced, and therefore, is formed on the lower cap substrate 10 by the WLP scheme. According to at least one embodiment, the process for forming an inertial sensor 300 to which the hermetic seal is applied requires a wafer level bonding (WLB) process.

According to at least one embodiment, the WLP scheme implements the hermetic seal of the 6-axis inertial sensor 300 using two wafers of the lower cap substrate 10 and the upper cap substrate 30 at a wafer level and then dicing it at the wafer level, and therefore there is no possibility that, for example, air, dust, particles, and moisture, as non-limiting examples, are stuck to or introduced into the 6-axis inertial sensor 300 at the time of the cutting operation.

According to at least one embodiment, the WLP scheme is a package scheme of assembling the 6-axis inertial sensor 300 on the wafer, which is not separated and implements a package with a simple procedure of coating a photosensitive insulating material on each inertial sensor on the wafer, connecting the wirings, and boding the upper cap substrate 30 and the lower cap substrate 10 which protect the inertial sensors. Accordingly, the WLP scheme reduces the assembling processes, such as the wiring connection and a plastic package, to simplify the process for manufacturing a package protecting the 6-axis inertial sensor 300 and removes, for example, plastic, a circuit board, and a wire for a wiring connection, as non-limiting examples, which are used in the existing formation process to drastically save costs. In particular, since the package process is progressed by an integrated process with the 6-axis inertial sensor 300, the WLP scheme reduces the size of the package, thereby achieving the miniaturization.

FIG. 7 is a cross-sectional view illustrating a process for bonding the lower cap substrate, which is provided with the second sensor of the multi-axis sensor according to an embodiment of the invention, on an embedded substrate. As illustrated in FIG. 7, the lower cap substrate 10 provided with the inertial sensor 300 is bonded on the embedded substrate I in which the earth magnetic field sensor 100 is embedded.

Although not illustrated, as the subsequent process, the solder ball pad 450 and the solder ball 470 are formed under the embedded substrate I. According to at least one embodiment, the signal of the earth magnetic field sensor 100 is directly connected to the solder ball pad 450 through the electrical wiring in the embedded substrate I.

Further, a plastic PKG process performing molding using, for example, a metal can and an epoxy, as non-limiting examples, is progressed. According to at least one embodiment, in bonding the lower cap substrate 10 on the embedded substrate I, a vertical conductive epoxy, such as ACF, is applied to perform gap filling, thereby minimizing a package area. Further, the 9-axis sensor is completed by progressing the foregoing process.

As described above, the multi-axis sensor according to an embodiment of the invention includes the lower cap substrate on which the first sensor configured of the 6-axis inertial sensor having the hermetic seal is directly formed by the WLP scheme and the embedded substrate in which the 3-axis earth magnetic field sensor is embedded to form the 9-axis sensor having the structure in which the lower cap substrate is bonded on the embedded substrate, such that the multi-axis sensor is miniaturized and reduces the power consumption.

Thus, in the multi-axis sensor according to an embodiment of the invention, since the 3-axis earth magnetic field sensor is embedded in the embedded substrate, the 9-axis sensor has a height lower than that of the structure in which the 3-axis earth magnetic field sensor is disposed on the 6-axis inertial sensor and the width of the 9-axis sensor is smaller than that of the structure in which the 3-axis earth magnetic field sensor is disposed at one side of the 6-asix inertial sensor, such that the multi-axis sensor is miniaturized.

Further, in the multi-axis sensor according to an embodiment of the invention, since the 6-axis inertial sensor is directly formed on the lower cap substrate by the WLP scheme to reduce the required area of the 6-axis inertial sensor, it has a size smaller than that of the 6-axis inertial sensor, which is formed by forming each of the inertial sensors by the SIP scheme, and then mounting the inertial sensors on the lower cap substrate, thereby achieving the miniaturization and improving the space utilization. According to at least one embodiment, the 6-axis inertial sensor formed by the method for forming a 3-axis acceleration sensor and a 3-axis angular velocity sensor, respectively, by the SIP scheme has a limitation in reducing the size due to the required area, for example, for each sensor formed by the SIP scheme.

Further, in the multi-axis sensor according to an embodiment of the invention, the 6-axis inertial sensor having the hermetic seal is directly formed on the lower cap substrate by the WLP scheme to more reduce the number of manufacturing processes than that of the 6-axis inertial sensor formed by being formed by the SIP scheme and then mounted on the lower cap substrate, thereby mass-producing the 6-axis inertial sensor at low cost to improve the productivity. According to at least one embodiment, the inertial sensors manufactured one by one by the method for forming a 3-axis acceleration sensor and a 3-axis angular velocity sensor, respectively, by the SIP scheme, are mounted on the lower cap substrate, such as the PCB using the die bonding, for example, electrically connected to each other by the wire bonding, and then finally manufactured in the single module as the metal can or the plastic package. As described above, since the inertial sensors need to be packed one by one, the package costs are increased and thus the manufacturing costs of the package process, which mounts and connects each sensor, is increased and since the throughput of the package process is slow, mass production is hardly implemented.

Further, in the multi-axis sensor according to an embodiment of the invention, the 6-axis inertial sensor is formed in the ASIC used as the lower cap substrate and the ASIC is bonded on the embedded substrate in which the 3-axis earth magnetic field sensor is embedded to make the 9-axis sensor and the ASIC be disposed to be close to each other, thereby achieving the miniaturization and reducing the power consumption.

Further, in the multi-axis sensor according to an embodiment of the invention, the 6-axis inertial sensor having the hermetic seal is directly formed on the substrate by the WLP scheme, thereby mass-producing the 6-axis inertial sensor at low cost, miniaturizing the 6-axis inertial sensor, and improving the reliability and performance of the hermetic seal.

As set forth above, according to various embodiments of the invention, the multi-axis sensor includes the embedded substrate in which the 3-axis earth magnetic field sensor is embedded and the lower cap substrate on which the 6-axis inertial sensor having the hermetic seal is directly formed by the WLP scheme to form the 9-axis sensor having the structure in which the lower cap substrate is bonded on the embedded substrate, thereby achieving the miniaturization and reducing the power consumption.

Further, the 6-axis inertial sensor having the hermetic seal is directly formed on the substrate by the WLP scheme and thus has a size smaller than that of the 9-axis sensor, which is formed by forming both of the 3-axis earth magnetic field sensor and the 6-axis inertial sensor by each SIP scheme and then mounting them on the substrate, thereby improving the space utilization, while achieving the miniaturization and reducing the number of manufacturing processes to improve the productivity.

Further, the 6-axis inertial sensor having the hermetic seal is directly formed on the substrate by the WLP scheme, thereby mass-producing the 6-axis inertial sensor at low cost, miniaturizing the 6-axis inertial sensor, and improving the reliability and performance of the hermetic seal.

Further, the 6-axis inertial sensor is formed in ASIC used as the lower cap substrate and the ASIC is bonded on the embedded substrate in which the 3-axis earth magnetic field sensor is embedded to make the 9-axis sensor and the ASIC be disposed to be close to each other, thereby achieving the miniaturization and reducing the power consumption.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiments of the present invention may suitably comprise, consist or consist essentially of the elements disclosed and may be practiced in the absence of an element not disclosed. For example, it can be recognized by those skilled in the art that certain steps can be combined into a single step.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

As used herein, the terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “according to an embodiment” herein do not necessarily all refer to the same embodiment.

Ranges may be expressed herein as from about one particular value, and/or to about another particular value. When such a range is expressed, it is to be understood that another embodiment is from the one particular value and/or to the other particular value, along with all combinations within said range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. A multi-axis sensor, comprising:
a first sensor embedded in an embedded substrate and configured to sense a position; and
a second sensor formed on a lower cap substrate bonded on the embedded substrate by a wafer level package scheme and configured to sense an inertial force.

2. The multi-axis sensor of claim 1, wherein the embedded substrate and the lower cap substrate are gap filled by having a vertical conductive epoxy interposed therebetween and bonded to each other.

3. The multi-axis sensor of claim 1, wherein the embedded substrate and the lower cap substrate each have a vertical length of 2 mm to 4 mm and a horizontal length of 1 mm to 2 mm.

4. The multi-axis sensor of claim 1, wherein the embedded substrate has a height of 100 μm to 300 μm.

5. The multi-axis sensor of claim 1, wherein the lower cap substrate comprises an electrical wiring formed in horizontal/vertical directions and is made of a hermetic seal bonding material.

6. The multi-axis sensor of claim 1, wherein the lower cap substrate is made of any one of low temperature co-fired ceramic, glass, interposer, application specific integrated circuit, and silicon.

7. The multi-axis sensor of claim 1, wherein the first sensor is a 3-axis earth magnetic field sensor, which is formed by a single-in-line package scheme to sense a position.

8. The multi-axis sensor of claim 7, wherein the earth magnetic field sensor has a width of 1 m² to 1.5 m².

9. The multi-axis sensor of claim 7, wherein one surface of the earth magnetic field sensor is provided with an electrode pad, and the other surface opposite to the one surface of the earth magnetic field sensor is bonded and embedded in a cavity formed on the embedded substrate, so that the electrode pad is exposed to the outside.

10. The multi-axis sensor of claim 9, wherein the electrode pad is formed on upper and lower surfaces or both sides of the earth magnetic field sensor.

11. The multi-axis sensor of claim 9, wherein the cavity is formed to be wider than the earth magnetic field sensor.

12. The multi-axis sensor of claim 9, wherein the embedded substrate comprises:
a core layer provided with the cavity;
an insulating layer deposited on a lower surface of the core layer to support the earth magnetic field sensor;
a plurality of wiring patterns formed on the core layer and electrically connected to the earth magnetic field sensor, which is boned and embedded in the cavity; and
a build-up layer stacked on an upper surface of the core layer including the earth magnetic field sensor.

13. The multi-axis sensor of claim 12, wherein the embedded substrate further comprises a plurality of through holes, which are formed by vertically penetrating through the build-up layer, the core layer, and the insulating layer and electrically connected to the earth magnetic field sensor through the wiring patterns.

14. The multi-axis sensor of claim 9, wherein the embedded substrate comprises:
a core layer provided with the cavity;
an insulating layer formed on a lower surface of the core layer to support the earth magnetic field sensor; and
a plurality of wiring patterns formed in the insulating layer and electrically connected to the earth magnetic field sensor, which is boned and embedded in the cavity.

15. The multi-axis sensor of claim 1, wherein the second sensor comprises a 3-axis acceleration sensor and a 3-axis angular velocity sensor.

16. The multi-axis sensor of claim 1, wherein the second sensor comprises a hermetic seal, which is made of any one of glass, silicon nitride and metal.

17. The multi-axis sensor of claim 1, wherein the second sensor comprises an upper cap substrate and the lower cap substrate, and the upper cap substrate and the lower cap substrate are each formed of an application specific integrated circuit.
